(19) United States
(12) Patent Application Publication
(10) Pub. No.: US 2002/0118094 A1
(43) Pub. Date: Aug. 29, 2002

(54) Chip resistor and method of making the same

(76) Inventors: Shigeru Kambara, Kyoto (JP); Toshihiro Teramae, Kyoto (JP)

Correspondence Address: Michael D. Bednarek, SHAW PITTMAN, 2300 N Street, N.W., Washington, DC, 20037-1138, US

(21) Appl. No.: 10/117,038

(22) Filed: Apr. 8, 2002

Related U.S. Application Data
(62) Division of application No. 09/626,307, filed on Jul. 26, 2000.

(30) Foreign Application Priority Data
Jul. 30, 1999 (JP) 11-216181
Aug. 25, 1999 (JP) 11-238786

(51) Int. Cl. H01C 1/012

(52) U.S. Cl. 338/309

(57) ABSTRACT

A resistor includes an insulating substrate, a resistive layer formed on the substrate, electrodes connected to the resistive layer, and a protection cover overlapping with the resistive layer. The resistive layer is made of tantalum. The resistive layer is processed into a predetermined pattern by photolithography in which a photo resist layer is formed by the spin coating method applied to a circular mother substrate.

### BACKGROUND OF THE INVENTION

1. Field of the Invention

The present invention relates to a chip resistor of the type which includes a resistive layer formed on a heat-resistant insulating substrate. In particular, it relates to a chip resistor whose resistive layer is made thin by e.g. sputtering or vacuum evaporation. The present invention also relates to a method of making such a chip resistor.

2. Description of the Related Art

An example of conventional thin-layer type chip resistor is disclosed in JP-A-57(1982)-10907. As shown in FIG. 2 of this Japanese document, the conventional resistor includes, among other things, an insulating substrate (15) and a plurality of thin resistive layers (2) stacked on the substrate (15). Each of the resistive layers (2) is made of nickel-chrome alloy.

Though the conventional resistor is advantageous in that the nickel-chrome resistive layers (2) are readily made by e.g. sputtering or vacuum evaporation, it has been found to suffer some disadvantages. For instance, the resistance of each resistive layer (2) is apt to vary unduly with time due to the nature of nickel-chrome alloy. Another disadvantage is that the temperature characteristic of resistance (TCR) of the resistive layer (2) is unduly large. This means that the resistance of the layer is greatly affected by variations in temperature. Thus, a device incorporating the conventional resistor may fail to function properly due to the unexpected change in resistance of the resistor.

### SUMMARY OF THE INVENTION

It is, therefore, an object of the present invention to provide a chip resistor capable of overcoming the above-described problems.

Another object of the present invention is to provide a method of making such a chip resistor.

According to a first aspect of the present invention, a resistor is provided which includes an insulating substrate, a resistive layer formed on the substrate, electrodes connected to the resistive layer, and a protection cover overlapping with the resistive layer. The resistive layer is made of tantalum.

Preferably, the electrodes may be made of nickel-copper ally.

According to a preferred embodiment, the electrodes are piled on the resistive layer.

According to another preferred embodiment, the protection cover is made of a photosensitive material. The photosensitive material may comprise a synthetic resin.

The resistor of the present invention may further comprise terminal bumps which are connected to the electrodes and caused to protrude from the protection cover.

Preferably, the resistive layer may include at least a first portion and a second portion which is greater in resistance than the first portion.

The first portion may be formed with a trimming groove for resistance adjustment. In addition, the second portion may have a wavy configuration.

According to a second aspect of the present invention, a method of making a resistor is provided. The method comprises steps of preparing an insulating mother substrate, forming a resistive layer on the mother substrate, forming a conductive metal layer on the resistive layer, processing the metal layer by photolithography, processing the resistive layer by photolithography, forming a protection layer to cover the resistive layer, and dividing the mother substrate into smaller pieces. The prepared mother substrate has a generally circular configuration.

Preferably, the mother substrate may be made of one selected from a group of an alumina ceramic material, aluminum nitride and sapphire glass.

Preferably, the method of the present invention may further comprise a step of removing glass substances from the mother substrate before the forming of the resistive layer.

According to a preferred embodiment, the method may further comprise a step of forming through-holes in the protection layer for exposing the metal layer, and a step of providing a connection element at each of the through-holes.

The method of the present invention may further comprise a step of heating conductive paste to form the connection element.

Preferably, the connection element may comprise a conductive bump.

Preferably, the step of processing the metal layer may include forming of a photosensitive resist layer by spin coating.

For performing the spin coating, the method of the present invention may further comprise a step of supplying material liquid for forming the resist layer to the mother substrate being rotated.

Preferably, the mother substrate may be first cut along first cut lines to be divided into a plurality of elongated pieces, and then cut along second cut lines transverse to the first cut lines.

In the above instance, the method may further comprise a step of forming terminal electrodes connected to the metal layer after the mother substrate is cut along the first cut lines.

Preferably, each terminal electrode may extend from a top surface of a corresponding one of the elongated pieces onto a bottom surface of said corresponding one of the elongated pieces.

Other features and advantages of the present invention will become apparent from the detailed description given below with reference to the accompanying drawings.

### BRIEF DESCRIPTION OF THE DRAWINGS

FIG. 1 is a sectional side view showing a chip resistor embodying the present invention;

FIG. 2 is a bottom view showing the pattern of the resistive layer of the above chip resistor;

FIG. 3 is a perspective view showing a mother substrate used for making the chip resistor of FIG. 1;

FIG. 4 is a sectional view showing the mother substrate with a resistive layer formed thereon;

FIG. 5 is a sectional view showing the mother substrate with an additional layer formed on the resistive layer;

FIG. 6 is a sectional view showing the mother substrate with a photosensitive resist layer formed on the two underlaid layers;

FIG. 7 illustrates how the photosensitive resist layer is formed on the mother substrate;

FIG. 8 is a sectional view showing the mother substrate with a photo mask placed on the photosensitive layer;

FIG. 9 is a sectional view showing the photosensitive layer part of which is removed;

FIGS. 10-11 show the arrangement of the electrodes formed on the resistive layer;

FIGS. 12-14 illustrate how the resistive layer is provided with a predetermined resistive pattern;

FIGS. 15-19 show how a protection layer is formed on the mother substrate;

FIGS. 20-21 show how terminal bumps are formed at the through-holes provided in the protection layer;

FIG. 22 is a sectional side view showing how the mother substrate is divided into smaller pieces;

FIGS. 23-25 show a different way of making a protection layer provided with through-holes;

FIG. 26 is a sectional side view showing terminal bumps formed at the through-holes of the protection layer; and

FIGS. 27-31 illustrate a different way of making a chip resistor embodying the present invention.

### DETAILED DESCRIPTION OF THE PREFERRED EMBODIMENTS

The preferred embodiment of the present invention will be described below with reference to the accompanying drawings.

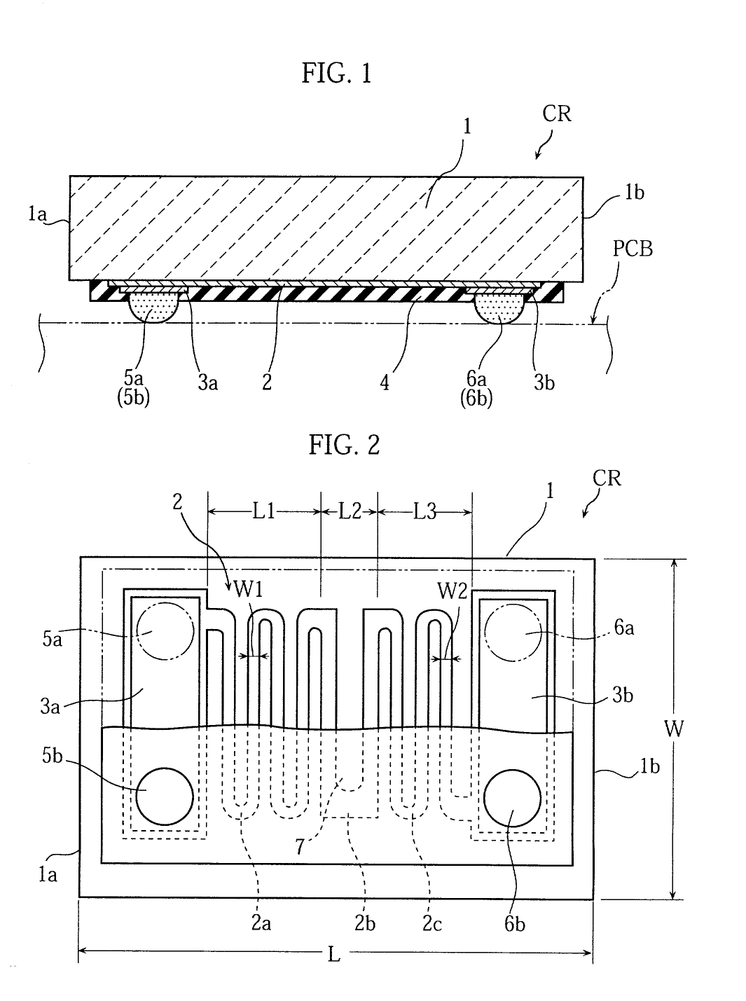

Reference is first made to FIGS. 1 and 2 illustrating a chip resistor CR embodying the present invention. Among other things the resistor CR includes a heat-resistant, insulating substrate 1 which is a rectangular solid. As shown in FIG. 2, the substrate 1 has a length L and a width W. The substrate 1 may be made of an alumina ceramic material containing alumina particles whose diameter is no greater than 1 μm. Alternatively, the substrate 1 may be made of aluminum nitride (exhibiting excellent heat dissipation) or sapphire glass (which is easily processed due to its low hardness).

Referring to FIG. 1, the substrate 1 has a principal surface (lower surface) on which a thin resistive layer 2 made of tantalum is formed. The substrate 1 also has a first side surface 1a and a second side surface 1b opposite to the first side surface. The first and the second side surfaces 1a, 1b are spaced from each other in the longitudinal direction of the substrate 1.

The resistive layer 2 is connected to a pair of thin electrodes: a first electrode 3a and a second electrode 3b. The first electrode 3a is arranged close to the first side surface 1a of the substrate, while the second electrode 3b is arranged close to the second side surface 1b. These electrodes are made of nickel-copper alloy for example. Specifically, nickel-copper alloy is formed into a thin layer by sputtering or vacuum evaporation for forming the electrodes.

The chip resistor CR is provided with a protection cover 4 for covering the resistive layer 2 and the first and second electrodes 3a, 3b. The protection cover 4 is made of heat-resistant synthetic resin or heat-resistant glass.

A first pair of terminal bumps (connection elements) 5a, 5b is formed on the first electrode 3a in electrical connection thereto, while a second pair of terminal bumps 6a, 6b is formed on the second electrode 3b in electrical connection thereto. These four bumps are made of tin (Sn) or solder. As shown in FIG. 1, each of the bumps 5a-6b is allowed to protrude from the protection cover 4 to be connected to the wiring pattern (not shown) formed on a printed circuit board (PCB).

As shown in FIG. 2, the resistive layer 2 is divided into three portions: a first portion 2a having a nominal length L1, a second portion 2b having a nominal length L2, and a third portion 2c having a nominal length L3. As viewed longitudinally of the substrate 1, the second portion 2b is located between the first and the third portions 2a, 2c.

The first portion 2a is a wavy path connecting the second portion 2b to the first electrode 3a. Similarly, the third portion 2c is a wavy path connecting the second portion 2b to the second electrode 3b. Since the substrate 1 is made of an alumina ceramic material containing alumina particles whose diameter is no greater than 1 μm, the width W1 or W2 of the first or third portion can be reduced to 1 μm with sufficient accuracy.

With such an arrangement, the resistance of the first and the third portions 2a, 2c is rendered greater than that of the second portion 2b. For adjusting the overall resistance of the resistive layer 2, a trimming groove 7 is formed in the second portion 2b.

According to the present invention, the resistive layer 2 is made of tantalum, which is less susceptible to corrosion than the nickel-chrome alloy used for making the resistive layer of the conventional resistor. Thus, the resistive layer 2 of the present invention undergoes a smaller variation in resistance than the conventional resistive layer of nickel-chrome alloy. Also, the melting point of tantalum is much higher than that of nickel-chrome alloy. Thus, as compared to the conventional resistive layer, the resistive layer 2 of the present invention can withstand higher temperature.

The above-described resistor CR may be produced in the following manner.

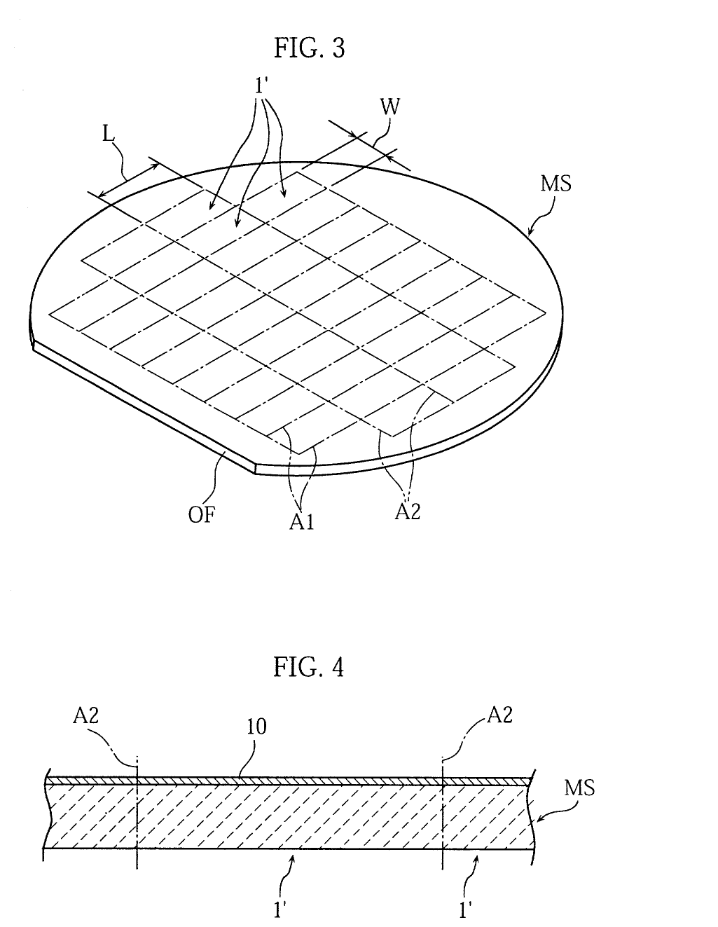

First, as shown in FIG. 3, a mother substrate MS provided with an orientation flat OF is prepared. It should be noted here that the mother substrate MS has a generally circular configuration rather than a rectangular one. The technical significance of this will be described later. The mother substrate MS is made of an alumina ceramic material containing alumina particles whose diameter is no greater than 1 μm. The mother substrate MS is large enough to provide a predetermined number of rectangular pieces 1′ when it is divided along the mutually perpendicular cut lines A1 and A2. Each piece 1′ has a length L and a width W. As seen from the figure, the cut lines A1 (called “first cut lines A1” below) extend perpendicularly to the orientation flat OF, whereas the other cut lines A2 (called “second cut lines A2” below) extend in parallel to the orientation flat OF.

The mother substrate MS is subjected to organic removal treatment using a water solution containing 1-3 wt % of potassium hydroxide (KOH). Thereafter, the mother substrate MS is washed by pure water. Then, the substrate MS is immersed in a cleansing liquid containing the equal amounts of nitric acid (HNO₃), hydrogen fluoride (HF) and water (H₂O). The immersion may be continued for 1-5 minutes.

Thereafter, the substrate MS is washed by pure water. In this manner, glass substances adhered to the surfaces of the mother substrate MS are removed.

Then, as shown in FIG. 4, a resistive layer 10 is formed on the mother substrate MS by sputtering or vacuum evaporation of tantalum. Though not illustrated, this layer-forming process is performed with the mother substrate placed in a vacuum chamber. As stated above, glass substances are removed from the mother substrate MS prior to the forming of the resistive layer 10. Thus, the TCR (temperature characteristic of resistance) of the resistive layer 10 is advantageously reduced from about ±100 ppm/°C. to about ±15 ppm/°C.

Thereafter, a plurality of paired electrodes (reference numeral 11′ in FIG. 10) are formed on the resistive layer 10 by photolithography. Specific procedures are as follows.

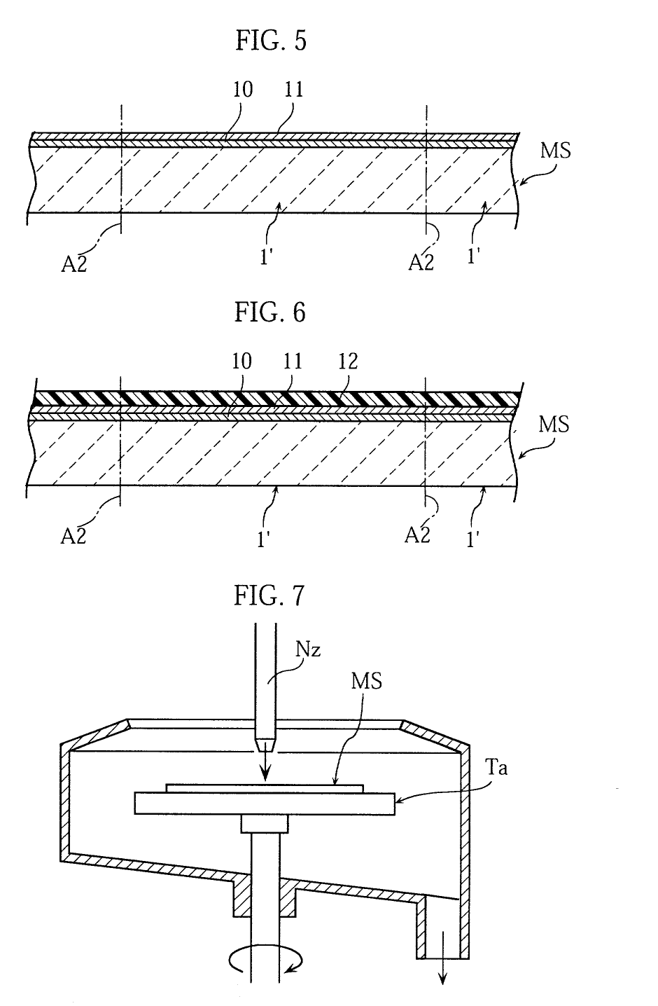

After the resistive layer 10 is formed (FIG. 4), a thin metal layer 11 is formed on the resistive layer 10, as shown in FIG. 5, by sputtering or vacuum evaporation of nickel-copper alloy. This step and the previous step for making the layer 10 are performed successively, without taking the mother substrate MS out of the non-illustrated vacuum chamber. In this manner, the metal layer 11 is firmly attached to the resistive layer 10 since substantially no impurities are trapped between the two layers.

Then, as shown in FIG. 6, a photosensitive resist layer 12 is formed on the metal layer 11. This resist layer may be made by a spin coating method as described below.

First, as shown in FIG. 7, the mother substrate MS is mounted on a rotatable table Ta. Then, while the table Ta is being rotated, a predetermined amount of material liquid for forming the resist layer is supplied from the nozzle Nz to the center of the mother substrate MS. The supplied liquid is caused to flow radially outward of the mother substrate MS by centrifugal force, and an excessive amount of it is sprinkled around off the edge of the mother substrate.

According to the present invention, the mother substrate MS is rendered generally circular. Thus, the excessive amount of material liquid for the resist layer will be sprinkled off equally over the circumference of the substrate MS. This is advantageous in providing the resulting resist layer 12 with a uniform thickness.

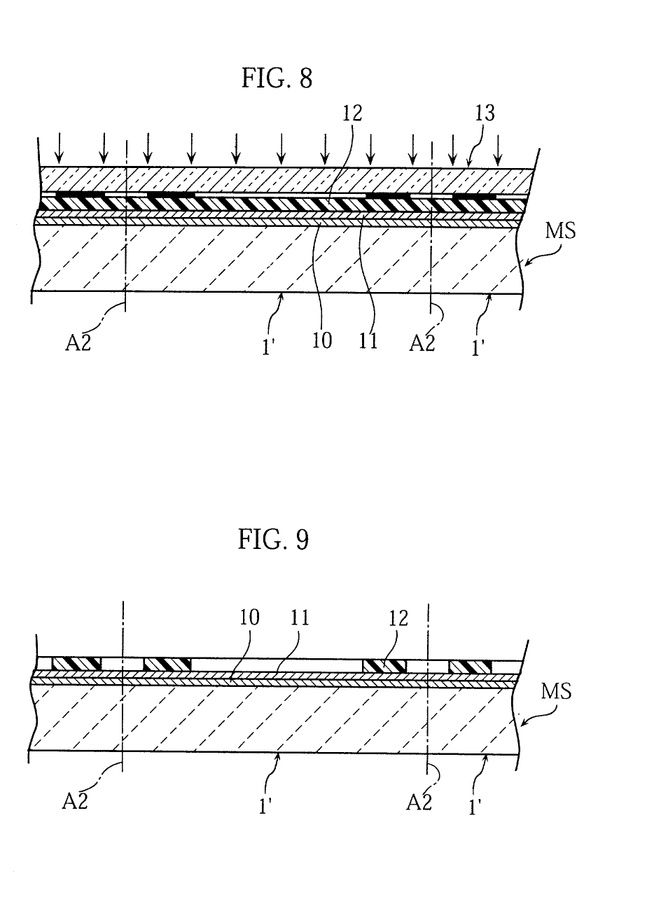

Then, as shown in FIG. 8, a photo mask 13 is placed on the resist layer 12. Though not shown, the photo mask 13 is provided with a predetermined pattern for selectively allowing (or blocking) the passage of light. With the photo mask 13 properly put on the resist layer 12, the multi-layer assembly is irradiated with light, as shown by the downwardly pointed arrows.

Then, the resist layer 12 is developed, so that the predetermined parts of the resist layer are removed, as shown in FIG. 9. In this connection, it should be noted that the resist layer 12 has a uniform thickness, as stated above. This is advantageous since the removal of parts of the resist layer 12 can be performed equally (i.e., regardless of where the parts to be removed are located in the resist layer 12).

As shown in FIG. 9, the metal layer 11 is partially covered by the remaining portions of the resist layer 12. The non-covered portions of the metal layer 11 are removed by etching. The etching liquid to be used should not corrode the resistive layer 10. An example of etching liquids meeting this requirement is a solution containing five parts of nitric acid (HNO₃), five parts of acetic acid (CH₃COOH), two parts of sulfuric acid (H₂SO₄) and one part of water (H₂O).

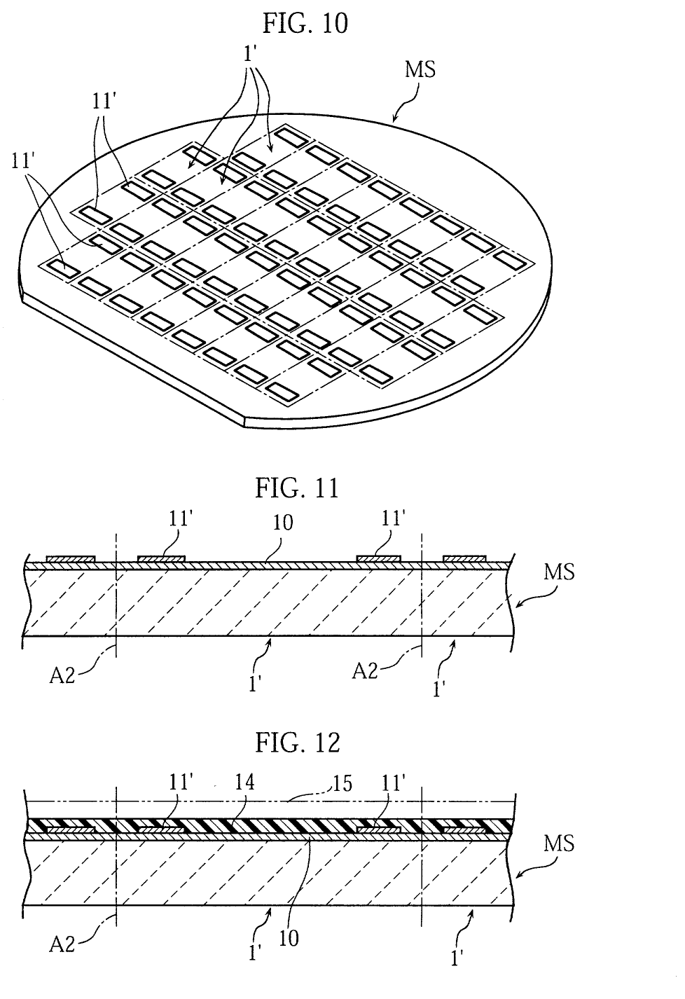

After the etching of the metal layer 11, the resist layer 12 is detached from the metal layer 11, which exposes a plurality of pairs of electrodes 11′. As shown in FIGS. 10 and 11, each of the electrode pairs is provided on a corresponding one of the rectangular pieces 1′.

Then, as shown in FIG. 12, a photosensitive resist layer 14 is formed on the resistive layer 10. As in the resist layer 12 (FIG. 6), the resist layer 14 is also made by the spin coating method.

Then, a photo mask 15 is stacked on the resist layer 14. Though not illustrated, the photo mask 15 is provided with a predetermined pattern for allowing the passage of light. This non-illustrated pattern of the photo mask 15 corresponds to the configuration of the resistive layer 2 shown in FIG. 2.

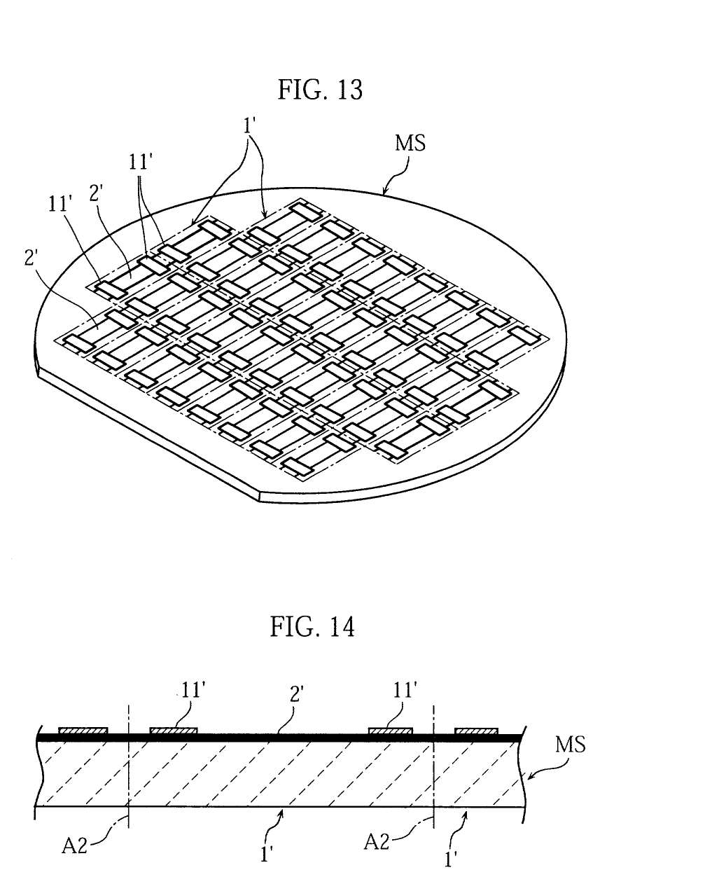

With the resist layer 14 partially covered by the photo mask 15, the resist layer 14 is irradiated with light and then developed. As a result of this, the resistive layer 10 is caused to have several portions which are non-covered by the resist layer 14. The non-covered portions of the resistive layer 10 are etched away by using e.g. hydrogen fluoride (HF). Then, the resist layer 14 is detached from the resistive layer 10. In this manner, as shown in FIGS. 13 and 14, a plurality of resistive portions 2′ are obtained, with each of them being disposed on a corresponding one of the rectangular pieces 1′.

Thereafter, a trimming groove (not shown) is formed in each resistive portion 2′ while the resistance of the resistive portion 2′ is being monitored.

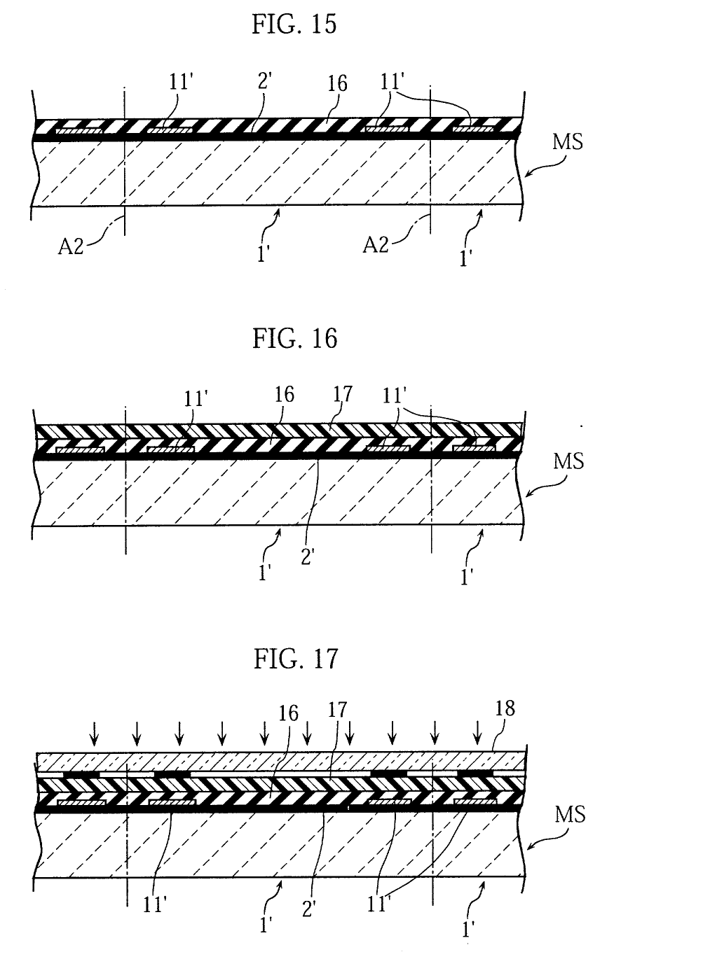

After the desired resistance is attained in the resistive portion 2′ by provision of the trimming groove, a protection layer 16 is formed on the mother substrate MS to enclose the resistive portions 2′ and the electrodes 11′, as shown in FIG. 15. The protection layer 16 may be made of glass, heat-resistant synthetic resin, silicon dioxide (SiO₂), etc.

Then, as shown in FIG. 16, a photosensitive resist layer 17 is formed on the protection layer 16.

Then, as shown in FIG. 17, a photo mask 18 is placed on the resist layer 17. Though not illustrated, the photo mask 18 is formed with a predetermined pattern for allowing the passage of light. While being partially covered by the mask 18, the resist layer 17 is irradiated with light, as shown by downwardly pointed arrows, and then developed.

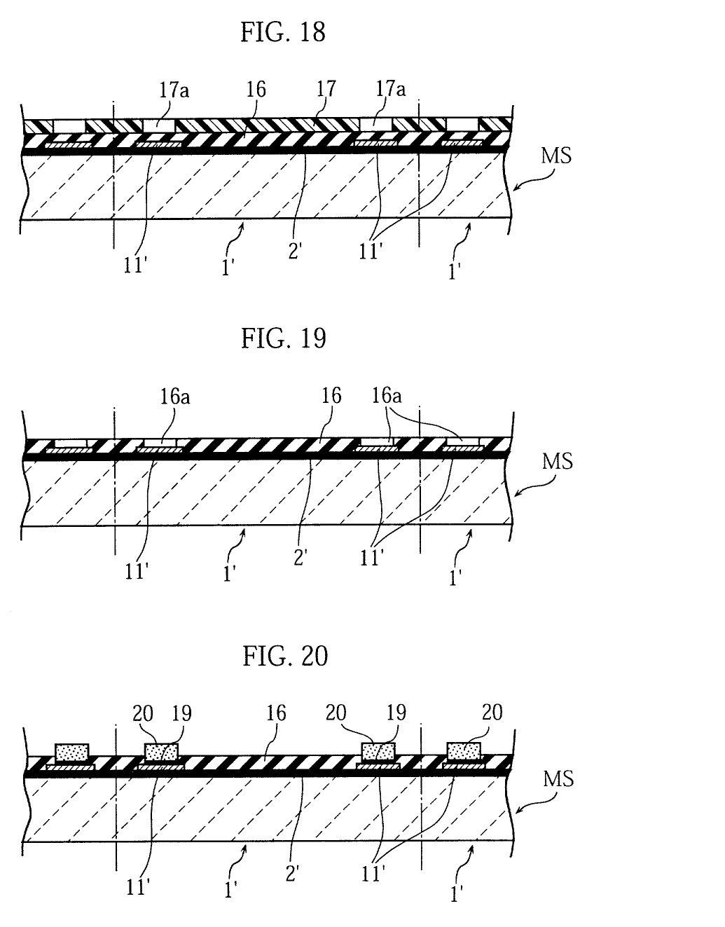

Thus, as shown in FIG. 18, a plurality of through-holes 17a are formed in the resist layer 17. As seen from the figure, each through-hole 17a corresponds in position to one of the electrodes 11′.

Then, as shown in FIG. 19, the predetermined portions of the protection layer 16 that are not covered by the resist layer 17 are etched away, thereby providing through-holes 16a in the protection layer 16. The through-holes 16a cause parts of the electrodes 11′ to be exposed to the exterior. After the through-holes 16a are formed, the resist layer 17 is detached from the protection layer 16.

Then, as shown in FIG. 20, a gold-plated layer 19 is formed at each through-hole 16a to be connected to the electrode 11′. The gold-plated layer 19 may be made by electroless plating. Then, conductive paste 20 made of tin or solder is provided at the respective through-holes 16a by e.g. screen-printing.

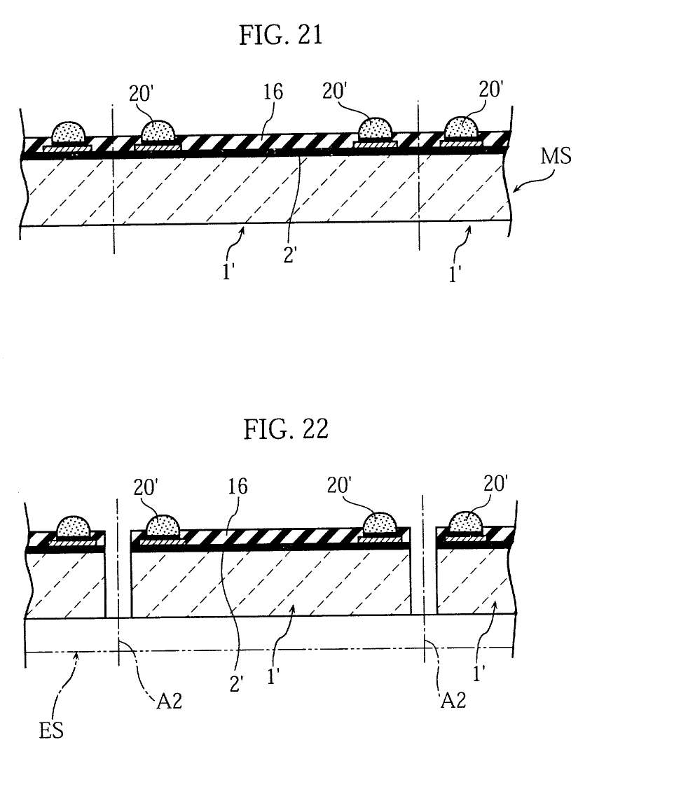

In this state, the conductive paste 20 is heated up to a temperature higher than its melting point, and then cooled down. Thus, as shown in FIG. 21, a plurality of terminal bumps 20′ protruding from the protection layer 16 are obtained.

Then, as shown in FIG. 22, an expansion sheet ES (double-dot chain line) is attached to the bottom surface of the mother substrate MS. Thereafter, the mother substrate MS is cut along the cutting lines A1, A2 (see FIG. 3) by e.g. a dicing cutter. Finally the expansion sheet ES is removed, which provides a plurality of chip resistors as shown in FIGS. 1 and 2.

According to the above-described method, the resist layer 17 (FIG. 16) is formed on the protection layer 16, and then the photo mask 18 is put on the resist layer 17 for making the through-holes 17a in the resist layer (FIG. 18). Thereafter, as shown in FIG. 19, through-holes 16a are formed in the protection layer 16 to receive the conductive paste 20 (FIG. 20) for making terminal bumps 20′ (FIG. 21).

The present invention, however, is not limited to this. Specifically, referring to FIG. 23, use may be made of a photosensitive, heat-resistant synthetic resin for making a protection layer 21 after the resistive portions 2′ are made (see FIG. 14).

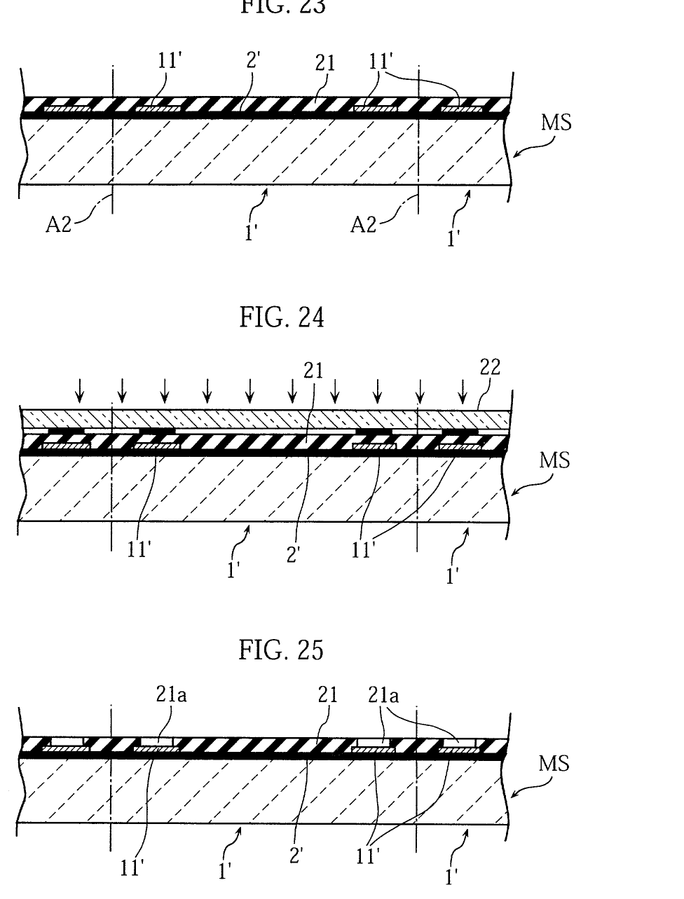

As shown in FIG. 24, a photo mask 22 provided with a predetermined pattern (for selectively allowing the passage of light) is placed on the protection layer 21. In this state, the protection layer 21 is irradiated with light, as shown by downwardly pointed arrows in FIG. 24, and then developed.

Thus, as shown in FIG. 25, a plurality of through-holes 21a are formed in the protection layer 21.

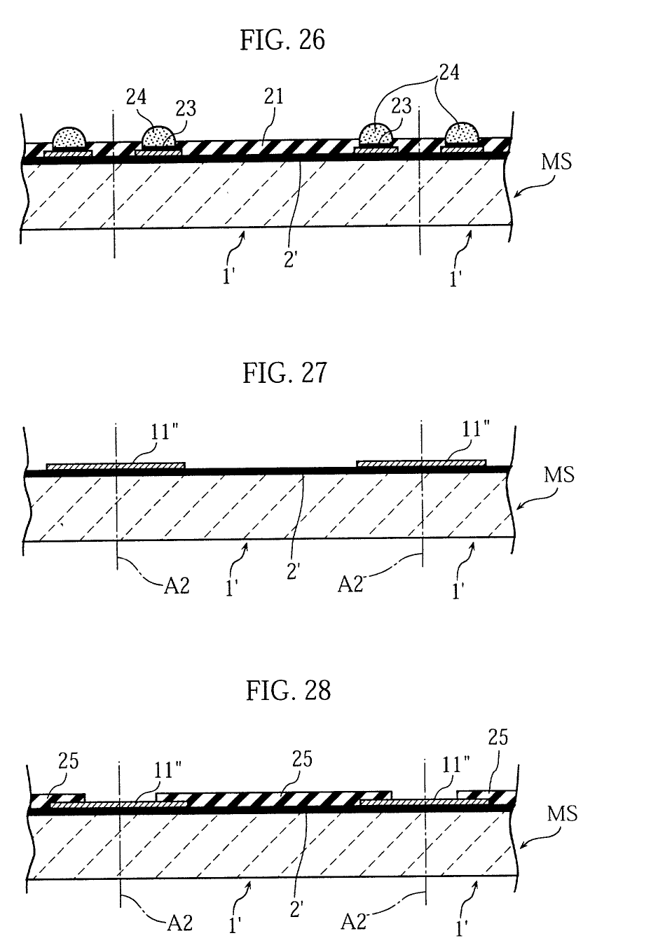

Thereafter, as shown in FIG. 26, a gold-plated layer 23 and a terminal bump 24 are formed at each through-hole 21a in the same manner as previously described with reference to FIGS. 20 and 21.

In the above manner, there is no need to form a photosensitive resist layer on the protection layer 21 for forming the through-holes 21a, as opposed to the previous method (see FIG. 16, reference numeral 17). Further, in the above manner, no etching process for the protection layer 21 is needed, as opposed to the previous method (see FIGS. 18 and 19). Thus, production costs are greatly reduced.

Reference is now made to FIGS. 27-30 illustrating a different method of making a chip resistor. According to this method, resistive portions 2′ and electrodes 11″ are formed on the mother substrate MS in the same manner as previously described with reference to FIGS. 3-14. It should be noted, however, that each electrode 11″ extends from a rectangular piece 1′ onto the adjacent piece 1′ across a cutting line A2, as shown in FIG. 27.

After the resistive portions 2′ and electrodes 11″ are formed, a protection layer 25 is formed on the mother substrate MS to enclose the resistive portions 2′ and part of each electrode 11′, as shown in FIG. 28. The central portion of each electrode 11′ is not covered by the protection layer 25 but exposed to the exterior. The protection layer 25 may be made of glass or heat-resistant synthetic resin by screen-printing.

The protection layer 25 may also be made of SiO₂. In this instance, first a layer of SiO₂ may be formed over the mother substrate MS, and then part of the SiO₂ layer may be removed by e.g. photolithography for partial exposure of the electrodes 11″. Further, use may be made of photosensitive resin material for forming the protection layer 25, as described above with reference to FIGS. 23-25.

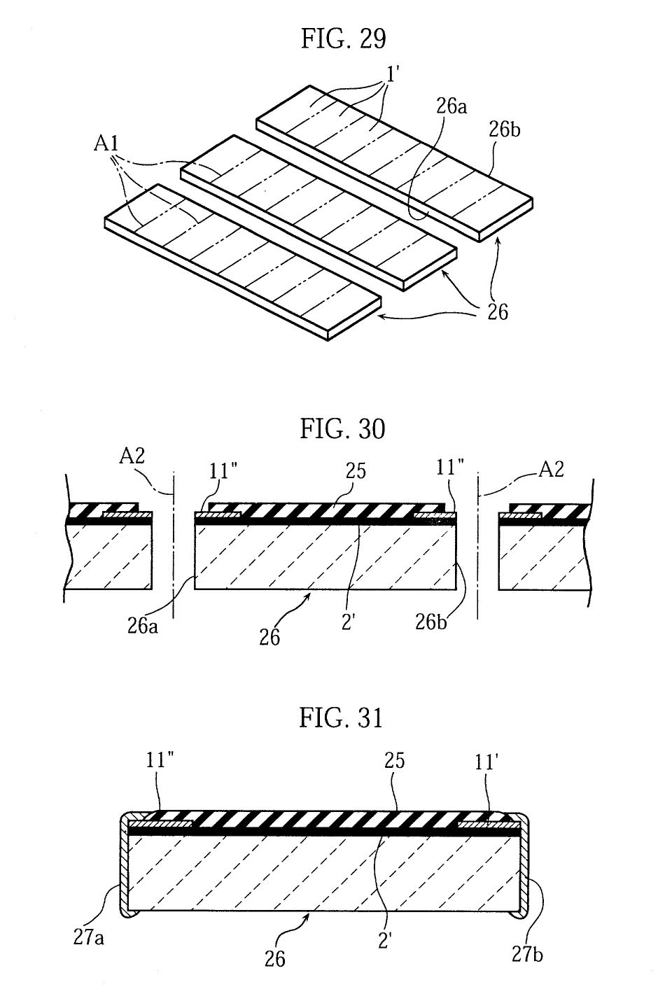

After the protection layer 25 is formed, as shown in FIG. 28, then the mother substrate MS is cut along the second cutting lines A2 to provide several intermediate elements 26, as shown in FIG. 29. Due to this cutting, each intermediate element 26 is provided with first and second side surfaces 26a, 26b (see FIGS. 29 and 30).

Then, conductive paste containing e.g. silver is applied to the first and the second side surfaces 26a, 26b of each intermediate element 26. Thereafter, the applied paste is baked to form a first terminal 27a and a second terminal 27b, as shown in FIG. 31. The first and the second terminals 27a, 27b are connected to the exposed portions of the electrodes 11′, extend over the first or second side surface 26a or 26b, and terminate on the bottom surface of the intermediate element 26.

Finally, each intermediate element 26 is cut along the first cutting lines A1 (see FIG. 29) to provide a plurality of product chip resistors.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A resistor comprising:
an insulating substrate;
a resistive layer formed on the substrate;
electrodes connected to the resistive layer; and
a protection cover overlapping with the resistive layer;
wherein the resistive layer is made of tantalum.

2. The resistor according to claim 1, wherein the electrodes are made of nickel-copper ally.

3. The resistor according to claim 1, wherein the electrodes are piled on the resistive layer.

4. The resistor according to claim 1, wherein the protection cover is made of a photosensitive material.

5. The resistor according to claim 4, wherein the photosensitive material comprises a synthetic resin.

6. The resistor according to claim 1, further comprising terminal bumps which are connected to the electrodes and caused to protrude from the protection cover.

7. The resistor according to claim 1, wherein the resistive layer includes at least a first portion and a second portion which is greater in resistance than the first portion.

8. The resistor according to claim 7, wherein the first portion is formed with a trimming groove for resistance adjustment.

9. The resistor according to claim 7, wherein the second portion has a wavy configuration.

10. A method of making a resistor comprising steps of:
preparing an insulating mother substrate;
forming a resistive layer on the mother substrate;
forming a conductive metal layer on the resistive layer;
processing the metal layer by photolithography;
processing the resistive layer by photolithography;
forming a protection layer to cover the resistive layer; and
dividing the mother substrate into smaller pieces;
wherein the prepared mother substrate has a generally circular configuration.

11. The method according to claim 10, wherein the mother substrate is made of one selected from a group of an alumina ceramic material, aluminum nitride and sapphire glass.

12. The method according to claim 10, further comprising a step of removing glass substances from the mother substrate before the forming of the resistive layer.

13. The method according to claim 10, further comprising a step of forming through-holes in the protection layer for exposing the metal layer, and a step of providing a connection element at each of the through-holes.

14. The method according to claim 13, further comprising a step of heating conductive paste to form the connection element.

15. The method according to claim 13, wherein the connection element comprises a conductive bump.

16. The method according to claim 10, wherein the step of processing the metal layer includes forming of a photosensitive resist layer by spin coating.

17. The method according to claim 16, further comprising a step of supplying material liquid for forming the resist layer to the mother substrate being rotated.

18. The method according to claim 10, wherein the mother substrate is first cut along first cut lines to be divided into a plurality of elongated pieces, and then cut along second cut lines transverse to the first cut lines.

19. The method according to claim 18, further comprising a step of forming terminal electrodes connected to the metal layer after the mother substrate is cut along the first cut lines.

20. The method according to claim 19, wherein each terminal electrode extends from a top surface of a corresponding one of the elongated pieces onto a bottom surface of said corresponding one of the elongated pieces.
